(19) United States
(12) Patent Application Publication
(10) Pub. No.: US 2007/0213644 A1
(43) Pub. Date: Sep. 13, 2007

(54) Method and apparatus to enhance attention in people suffering from attention deficit disorder, autism an sensory integration disorders

(75) Inventors: Michael D. Pagel, (US); Pamela A. Pagel, (US)

Correspondence Address: PACIFIC PEDIATRIC SUPPLY LLC, 32556 Armoise Dr., Winchester, CA, 92596, US

(73) Assignee: PACIFIC PEDIATRIC SUPPLY LLC, A California Limited Liability Company

(21) Appl. No.: 11/371,046

(22) Filed: Mar. 9, 2006

(51) Int. Cl. A61H 1/02

(52) U.S. Cl. 601/23

(57) ABSTRACT

The present invention provides a method and apparatus enabling non-invasive treatment of individuals affected by attention disorders, autism and sensory integration disorders and related dysfunctions (“Attention Disorders”). More particularly the present invention is developed as a classroom accommodation enabling individuals to exercise skating like motions while comfortably sitting down resulting in enhanced proprioception aiming to combat Attention Disorders with the advantage of enabling affected individuals to focus on learning, in a real class environment, an unlimited umbrella of topics and acquire real-time and “real world” knowledge.

### BACKGROUND OF THE INVENTION

1. Field of the Invention

The present invention relates to the non-invasive treatment of Attention Deficit Disorder (“ADD”), Attention Deficit with Hyperactivity Disorder (“ADHD”), autism and Sensory Integration Disorder (“SID”), and associated dysfunctions hereinafter severally and conjunctly referred to as “Attention Disorders”. More particularly the present invention was developed as a classroom accommodation aiming to combat Attention Disorders with the advantage of enabling affected students to focus on learning, in a real class environment, an unlimited umbrella of topics and acquire real world knowledge which enables the individual to graduate in a or several field(s) of expertise and ultimately engage in a normal career path at a later age.

2. Prior Art

Attention Disorders affect several individuals and are well known to prevent regular learning which prevents affected students from normal intellectual development with serious negative impact on career development at a later age.

Although some methods and devices for measuring attention levels and attention deficits have been developed (see for example U.S. Pat. No. 4,730,253 Gordon 1988; U.S. Pat. No. 5,577,919 Collins et al. 1996; U.S. Pat. No. 6,053,739 Stewart et al. 2000) limited success has been achieve in the development of therapeutics for Attention Disorders. Several chemical therapies have been developed in order to enhance intellectual attention in affected students (see for example U.S. Pat. No. 5,885,998 Bencherif et al. 1999). Chemical therapy, however, has undesirable side effects and may not be suitable for long term treatment especially for patient of young age.

Some non-invasive devices such as video games and virtual reality have been developed, however they do not constitute a regular class accommodation and thus do not offer the advantage of assisting students in real-time, real class, real world learning (see for example U.S. Pat. No. 5,377,100 Pope et al. 1994; U.S. Pat. No. 6,425,764 Larmson 2002).

Thus the therapies so far developed are either toxic or do not address real class accommodation for normal multi-topic learning. The present invention addresses this need and offers real-time learning and is based on the understanding of the importance of proprioception during class learning.

Students affected by Attention Disorders are seen once or twice a week for sensory motor therapy. The therapy provides students with sensory input that stimulates proprioception and other sensory systems in order to help the brain understand and use sensory information purposefully.

Proprioception is the sense that tells us where our body parts are. The receptors are located in joints, tendons, and muscles. These receptors, when stimulated, provide the brain with information concerning body position. They also aid in the release of neurochemicals that are calming and give a sense of well being. The excessive movement and disruptive behaviors of Attention Disorders affected students are similar to feeling the need to shift ones weight after standing or sitting in one place for “too long”, or needing the comfort of a hug or massage. Both for these individuals the need is highly amplified and behaviors are typically impulsive and negative. Currently, students are receiving occupational therapy, specifically Sensory Motor Therapy (using trampolines, weighted blankets, weighted lap animals and other techniques for tension release) in order to help the student feel comfortable and teachable when they return in the classroom.

The current invention addresses the need for enhanced proprioception while simultaneously learning at the same time.

### SUMMARY OF THE INVENTION

The apparatus herein disclosed and described achieves the above mentioned goals by providing students with a quiet, non-invasive, non-obtrusive, kinetic, modality for proprioceptive stimulation. Students are able to receive additional stimulation through the knee and ankle joints and mild pressure through the bottoms of the feet. The invention can be used in classroom all day long.

The apparatus enables non-invasive treatment of Attention Disorders. More particularly the present invention is developed as a classroom accommodation aiming to combat Attention Disorders with the advantage of enabling affected students to focus on learning, in a real class environment, an unlimited umbrella of topics and acquire real-time and real world knowledge. With respect to the above description, before explaining at least one preferred embodiment of the herein disclosed invention in detail, it is to be understood that the invention is not limited in its application to the details of construction and the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting. As such, those skilled in the art will appreciate that the conception, upon which this disclosure is based, may readily be utilized as the basis for the design of other structures, methods, and systems for carrying out the several purposes of the present disclosed apparatus. It is important, therefore, that the claims be regarded as including such equivalent construction and methodology insofar as they do not depart from the spirit and scope of the present invention.

### BRIEF DESCRIPTION OF THE DRAWING FIGURES

FIG. 1 is a perspective view on the rectangular skating board (of a first preferred embodiment) made of a frame embedding movable skating wheels (spherical components) supported by a series of dowels covering the surface of the frame.

FIG. 2 is a perspective view on the holder/base (of a first preferred embodiment) made of a box designed to stably sit on a floor while securing the skating board described in FIG. 1 in an horizontal position for easy foot accommodation.

FIG. 3 is a perspective view of both components described in FIG. 1 and 2 in addition to a perspective view on the assembled apparatus to form the first preferred embodiment.

### DETAILED DESCRIPTION OF THE FIRST PREFERRED EMBODIMENT OF THE INVENTION

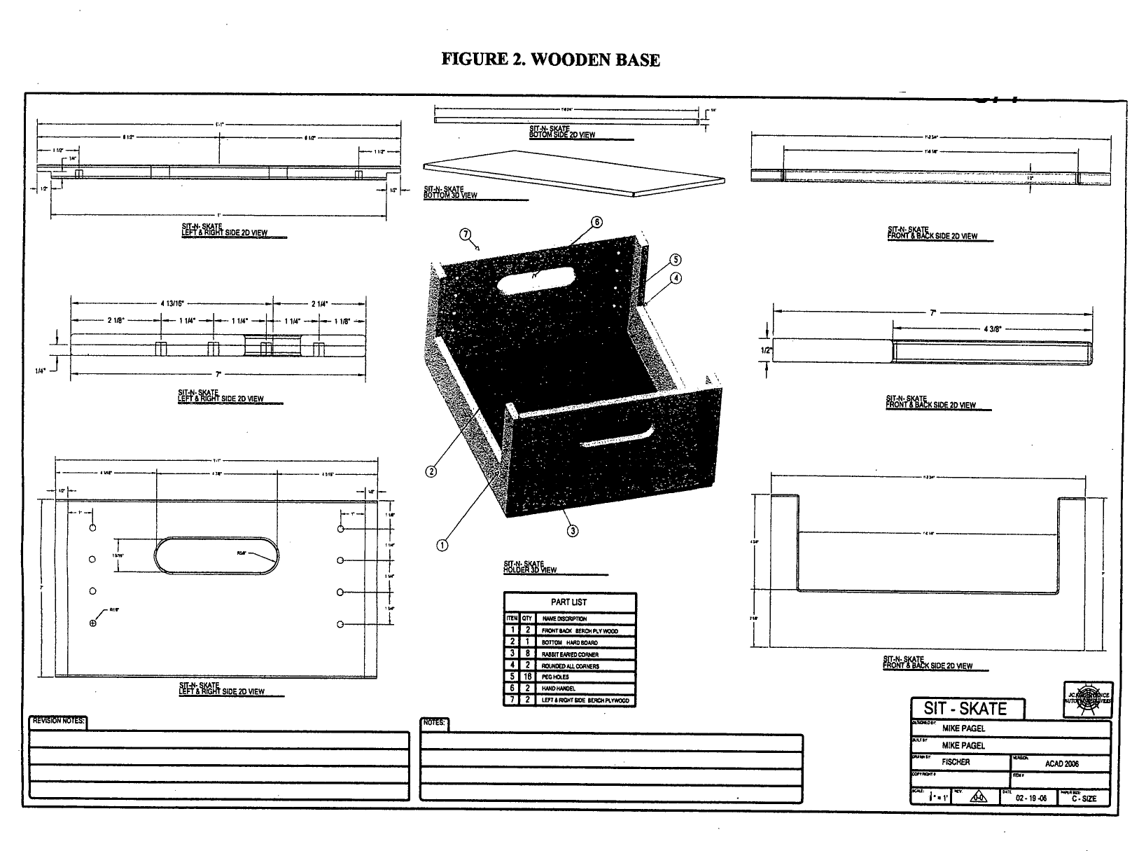

The first preferred embodiment is composed of two major parts a wooden base (as displayed in FIG. 2 and a skating board also made of wood both embedding smaller components described below. It should be noticed that the base contains peg holes (item 5, FIG. 2) in order to better accommodate users legs which may differ in length.

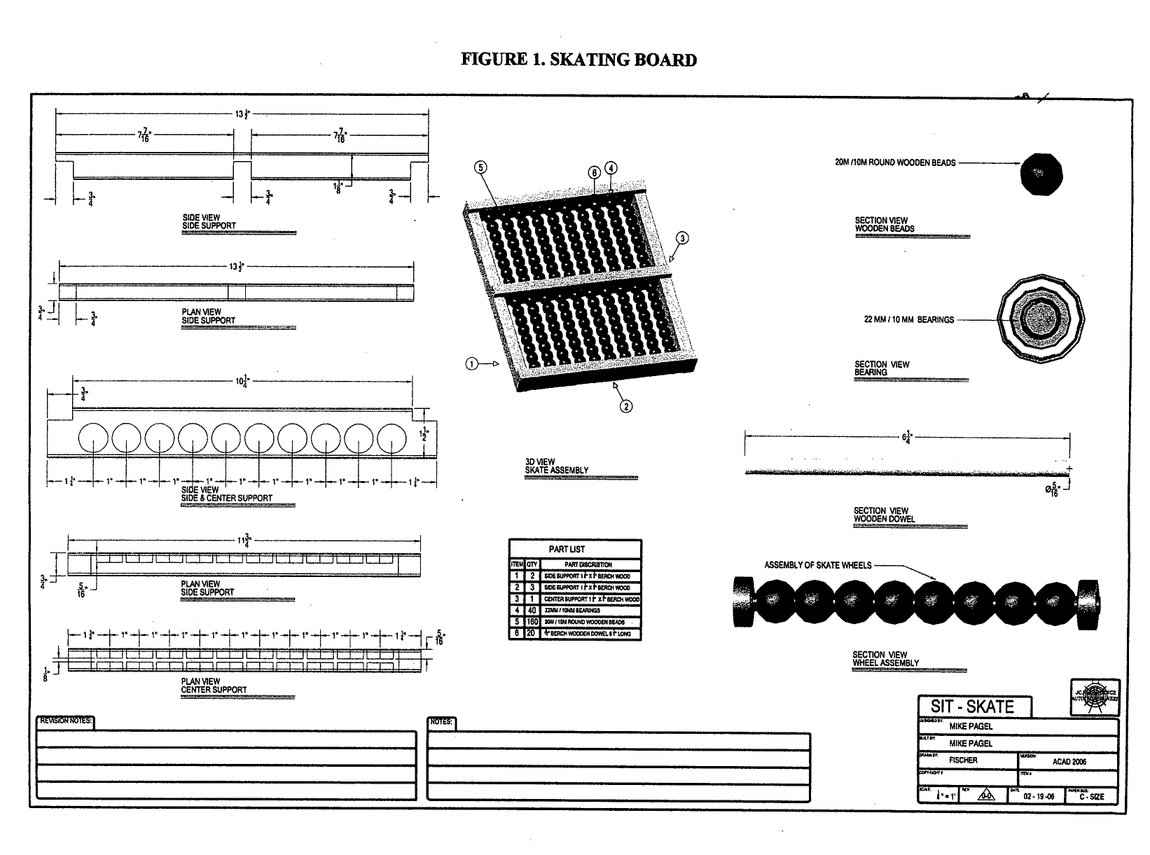

As depicted in FIG. 1, the skating board consists of a rectangular frame composed of two 13½ inches long wooden side support (item 1), attached to two wooded 10¼ inches side supports (item 2) and one wooden center support (item 3). The side supports have been carved at the center and in each extremity in order to accommodate the side support that are glued in the carved area in a male/female manner. Ten holes are drilled on the inner side of the outer side supports in order to accommodate ten 22 mm/10 mm metallic bearings, (item 4) and similarly the center side support contains ten holes on each side in order to accommodate twenty bearings (10 on each side) which bearings secure the extremities of twenty wooden dowels (item 6). Each dowel is 6¼ inch in length and pass thur the center of eight 20 mm/10 mm round wooden beads (item 5). The beads can be perfectly spherical or polygonal at the surface. The beads allow for easy skating like motion of the user's feet which are held on the skating board and separated by the center support (item 3).

In the first preferred embodiment the skating board (FIG. 1) is secured into a wooden base with flat bottom which sits on the floor (FIG. 2). The base is composed of two plywood front back sides with a U-shape (item 1) attached to two plywood left and right sides (item 7) which are glued together in a male/female manner. The U-shape (feature 4) in the two front back sides facilitates access to the different levels (determined by the positions of the sixteen peg holes (item 5)) where the skating board can be placed. Furthermore the two front back sides contain hand handles (feature 6) for easy transportation.

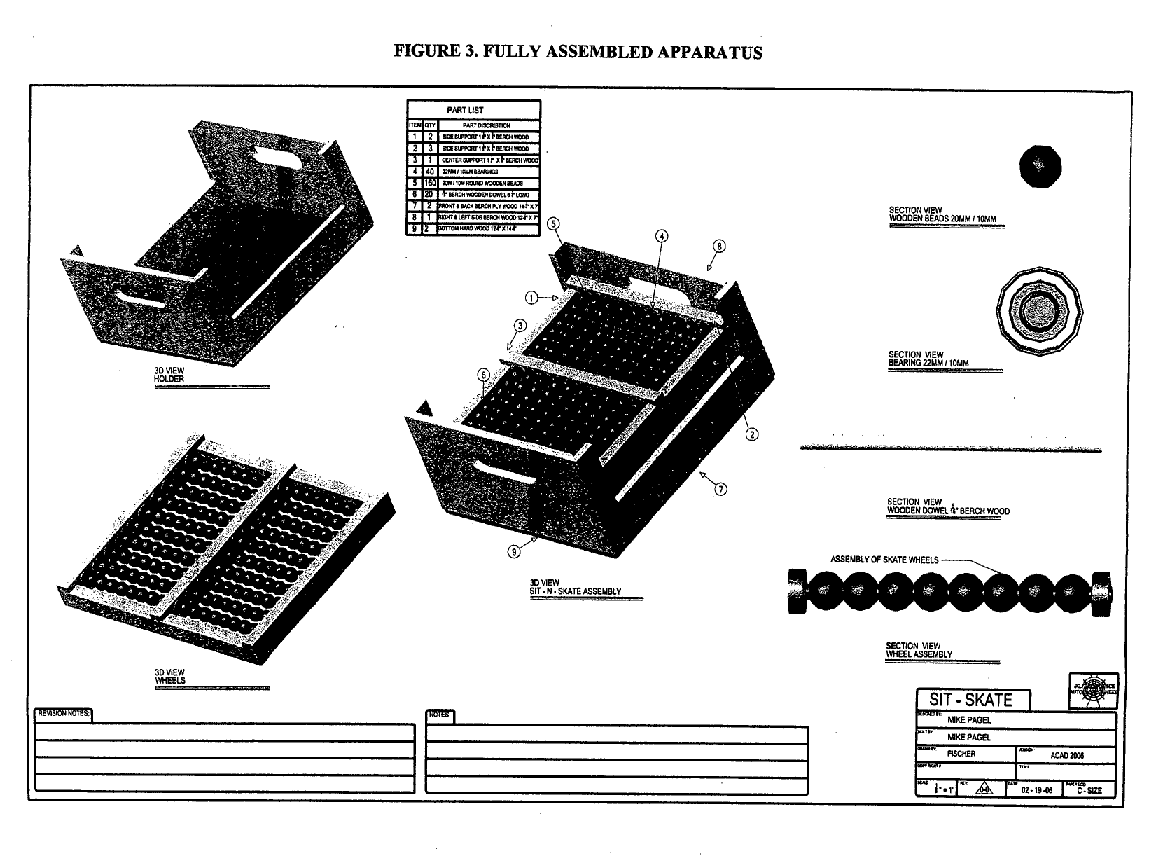

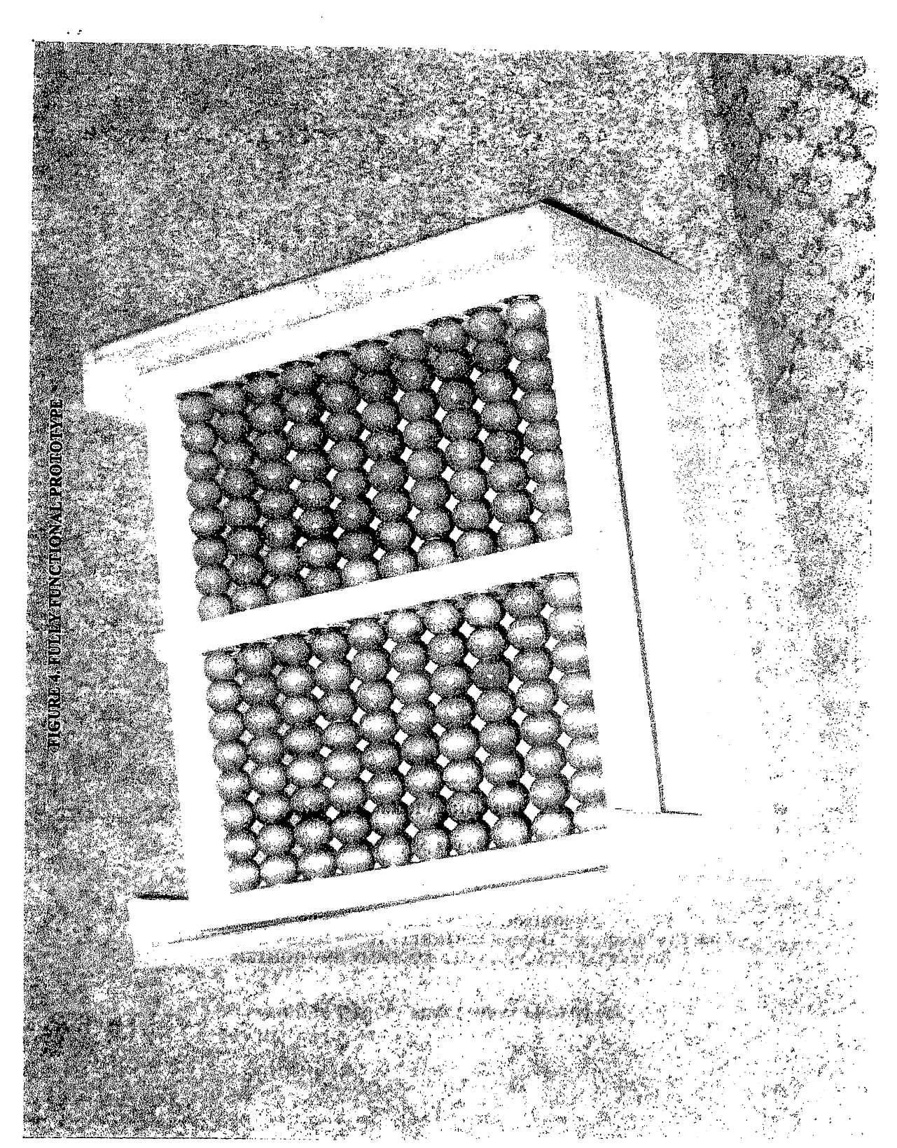

In the first preferred embodiment four bookshelf-like pins are placed in the peg holes (item 5) of the wooden based at the desired level and the skating board stands on these pins as depicted in FIG. 3. The fully operational apparatus sits on the floor which is in direct contact with a the bottom hard wood part of the base (item 9).

A fully functional prototype has been tested and is shown in FIG. 4.

### DESCRIPTION OF OTHER PREFERRED EMBODIMENTS OF THE INVENTION

Although testing of the apparatus shown in FIG. 4 has demonstrated satisfactory stability, in another preferred embodiment, the possible mobility of the wooden base relative to the floor could be restrained by attaching 4 suction cups on each corner of the base hard wood bottom for strong adherence to flat hard surface floors such as tile, wood, marble and the like while Velcro could be used as an alternative to the suction cups for carpeted floors.

Although the first preferred embodiment as shown in FIG. 3 and 4 provides a nicely transportable system, another preferred embodiment consists of the present invention without the wooden base. In lieu of the base, suction cups or Velcro could be placed in the four corners of the rectangular skating frame for direct attachment to the floor. This system would however be more suitable for users sitting on adjustable height chairs. In the event regular classroom chairs are used the wooden base enables better accommodation of different leg lengths.

In another preferred embodiment the dowels can be replaced by a series of semi-spherical receptacles each embedding a multidirectional rolling bead. This would allow for more degree of freedom and may offer some advantages. In this case the skating frame would have to include a bottom surface on which the 160 bead receptacles can stand.

Although the beads model seems to offer the smoothest system, in another embodiment the dowel/beads or receptacle/bead parts could be replaced by rolling cylinders or rolling straps/carpet.

Although wood was used as a preferred material in the above described embodiments, alternative materials can be used including plastic which could be molded or metal which could also be molded.

1. An apparatus to improve attention in individual suffering from attention deficit disorders, autism and sensory integration disorders comprising a skating board composed of a wooden frame embedding a series of beads (supported by wooden dowels) enabling skating-like motion of the feet and legs and which board stands on a transportable wooden base.

2. An apparatus of claim 1 wherein:
The base stability to the floor is improved by the implementation of suction cups attaching to hard surface floors or Velcro system attaching to carpeted floors to include configuration wherein the skating board is directly attached to the floor via such suction cups or Velcro system or any other attachment mechanism and/or
The dowels supporting the beads are replaced by 160 semi-spherical receptacles embedding each bead for multi-directional movement and higher degree of freedom.

3. An apparatus of claim 1 and 2 wherein wooden components are replaced by plastic or metallic parts which can be molded.

4. An apparatus of any configuration to include apparatus of claims 1 to 3 wherein such configuration enables smooth motion of the feet of the user while sitting and attending class thus improving his/her level of attention and reducing/combating the symptoms of attention deficit disorders, autism and sensory integration disorders.

5. A method using the apparatus of claim 1 to 4 enhancing proprioception via skating-like motion of the feet and enabling individual affected by attention deficit disorders, autism and sensory integration disorders and associated dysfunctions to attend regular multi-topic classes and consequently acquiring the necessary knowledge which will ultimately facilitate their social integration and improve their career opportunities.
